(19) United States
(12) Patent Application Publication
(10) Pub. No.: US 2015/0206072 A1
(43) Pub. Date: Jul. 23, 2015

(54) SYSTEM AND METHOD FOR PROVIDING A BEST FIT TRAVEL SERVICE RECOMMENDATION

(71) Applicant: Traxo, LLC, Dallas, TX (US)

(72) Inventors: Andres Fabris, Dallas, TX (US); Richard Pendergast, Gainesville, TX (US)

(21) Appl. No.: 14/599,956

(22) Filed: Jan. 19, 2015

Related U.S. Application Data
(60) Provisional application No. 61/928,672, filed on Jan. 17, 2014.

(51) Int. Cl. G06Q 10/02; G06Q 30/06

(52) U.S. Cl. CPC G06Q 10/02; G06Q 30/0631

(57) ABSTRACT

A system performs a method for recommending travel services based on a user's past travels. The method includes determining that a travel service is required for a trip destination of a user; selecting a pool of travel services associated with the trip destination; filtering the pool of travel services into a filtered group of travel services using one or more filters; sorting the filtered group of travel services into a list using one or more sort criteria; and displaying the list on a display for the user. The travel service search has multiple levels of searching for travel services that customizes the displayed recommended travel service list to the user. Unique filters and sorts are used to display a list of travel services that is relevant to the user, instead of an arbitrary list.

### CROSS-REFERENCE TO RELATED APPLICATIONS

The present application claims priority to U.S. Provisional Application No. 61/928,672 filed on Jan. 17, 2014, which is incorporated herein by reference.

### TECHNICAL FIELD

The present disclosure relates to a system and method for searching for a hotel or other travel service and providing one or more recommendations based on a user's stored profile information, loyalty preferences, previously submitted reviews, past travels, and/or previously booked travel.

### BACKGROUND

With the convenience of the internet, the need to call many different hotels or other travel services for price checks and availability is coming to an end. Booking travel services online is more popular than ever. Many travel sites lists hotels or other travel services where the user is traveling. The list of hotels is normally randomized and has no specific customization to the individual user. In many cases, the search results are presented to the user based on distance from an arbitrary location or are based upon ultimate profitability for the website or travel service supplier.

### SUMMARY

This disclosure provides a system and method for searching for a hotel or other travel service and providing one or more recommendations based on a user's stored profile information, loyalty preferences, previously submitted reviews, past travels, and/or previously booked travel.

In a first embodiment, a method for recommending travel services is provided. The method includes determining that a travel service is required for a trip destination of a user; selecting a pool of travel services associated with the trip destination; filtering the pool of travel services into a filtered group of travel services using one or more filters; sorting the filtered group of travel services into a list using one or more sort criteria; and displaying the list on a display for the user.

In a second embodiment, a system for recommending travel services is provided. The system includes at least one memory and at least one processor coupled to the at least one memory. The at least one processor is configured to determine that a travel service is required for a trip destination of a user, select a pool of travel services associated with the trip destination, filter the pool of travel services into a filtered group of travel services using one or more filters, sort the filtered group of travel services into a list using one or more sort criteria, and display the list on a display for the user.

In a third embodiment, a non-transitory computer readable medium is provided. The non-transitory computer readable medium embodies a computer program comprising computer readable program code for determining that a travel service is required for a trip destination of a user; selecting a pool of travel services associated with the trip destination; filtering the pool of travel services into a filtered group of travel services using one or more filters; sorting the filtered group of travel services into a list using one or more sort criteria; and displaying the list on a display for the user.

Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, in which:

FIG. 1 illustrates a block diagram of a hotel search and display method in accordance with the present disclosure;

FIG. 2 illustrates a block diagram of a searching method in accordance with the present disclosure;

FIG. 3 illustrates a number of search filters that may be used in accordance with the present disclosure;

FIG. 4 illustrates a block diagram of a hotel sort function in accordance with the present disclosure; and

FIG. 5 illustrates an example of a computing device 500 for performing all or a portion of any of the methods for hotel or travel searching described herein.

### DETAILED DESCRIPTION

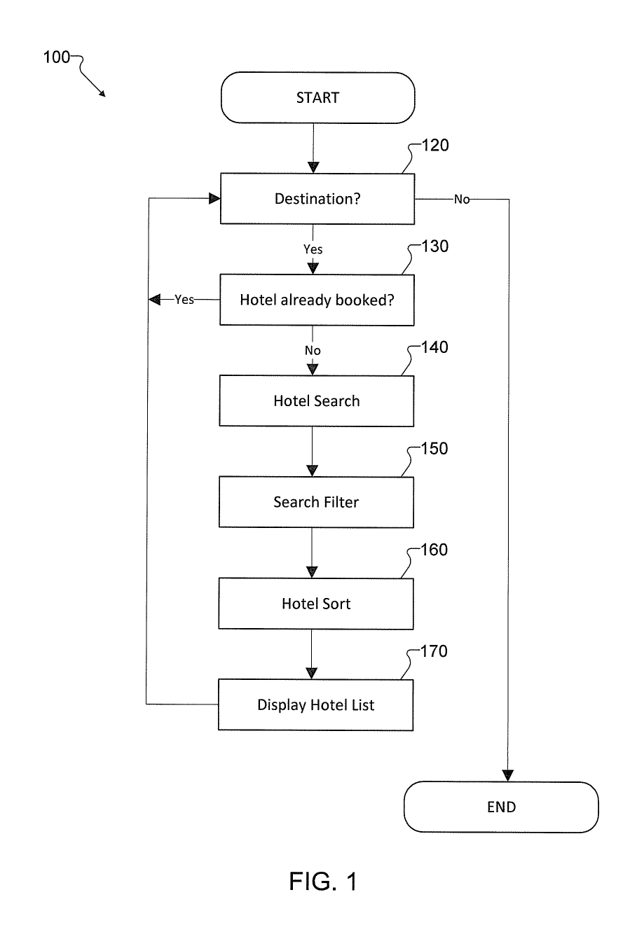

FIGS. 1 through 5, discussed below, and the various embodiments used to describe the principles of the present disclosure are by way of illustration only and should not be construed in any way to limit the scope of the disclosure. Those skilled in the art will understand that the principles of the disclosure may be implemented in any suitably arranged hotel search.

Embodiments of the present disclosure provide a system and method for presenting a user with a customized list of recommended hotels or other travel services directed at the individual user for the travel destination. When the user shows interest in traveling to a location, a hotel search is performed for that location.

In some embodiments, the system gathers and stores current and past travel itineraries. Before the hotel search is performed for a location, the system checks to see if the user already has a current or past hotel booking for that location area. The system can predict that a user prefers to stay in hotel properties in the same area based on current and past hotel bookings, find such hotel properties, filter and sort the found hotel properties, and then display the properties to the user, such as in a list. If the user has no current or past hotel bookings for that location area, the system can gather current or past data regarding activities of the user in the location area (e.g., restaurants visited, sporting events or concerts attended, businesses visited, etc.) and perform a proximity search for hotels based upon the geographic center of those activities.

In some embodiments, the system allows the user to connect with the user's travel buddies. The system can predict that a user prefers to stay in hotel properties that the user or the user's travel buddies have previously stayed. The system can also predict that a user prefers to stay in hotels that are in areas of the travel location near where the user or the user's travel buddies have previously stayed. If the user's travel buddies have no current or past hotel bookings for that location area, the system can gather current or past data about activities of the user's travel buddies (e.g., restaurants visited, sporting events or concerts attended, businesses visited, etc.) and perform a proximity search for hotels based upon the geographic center of those activities.

In some embodiments, the system also acquires information about the user's preferred traveler loyalty accounts. The system can predict that a user prefers to book hotels in hotel chains in which the user already has a loyalty account. Preference can be given to loyalty accounts where a user has obtained a higher (e.g., more elite) level of membership.

In some embodiments, the system can also predict that a user prefers not to stay at hotel properties in which the user or the user's travel buddies had previously given a poor feedback rating, unless the system detects that the user has a history of continuing to stay at that hotel property regardless of the previously poor feedback rating.

In some embodiments, the system can also predict that the user prefers to stay in hotel properties with quality ratings that are consistent with the user's past history with respect to quality ratings (e.g., a traveler who has a history of booking four star hotels is less likely to book a two star hotels).

In some embodiments, the system can also predict that the user prefers to stay in hotel properties with an average price per room-night that is consistent with the user's past history with respect to price per room-night (e.g., a budget traveler who has a history of booking $80 per room-night hotels is less likely to book a premium $300 per room-night hotel).

In some embodiments, the system can also predict that the user prefers to stay in the same hotel properties that other travelers who have similar traveler savvy (e.g., based upon a TRAXO travel score) have booked.

All of the predictions above may vary for business travel versus personal travel. These features will now be described in greater detail.

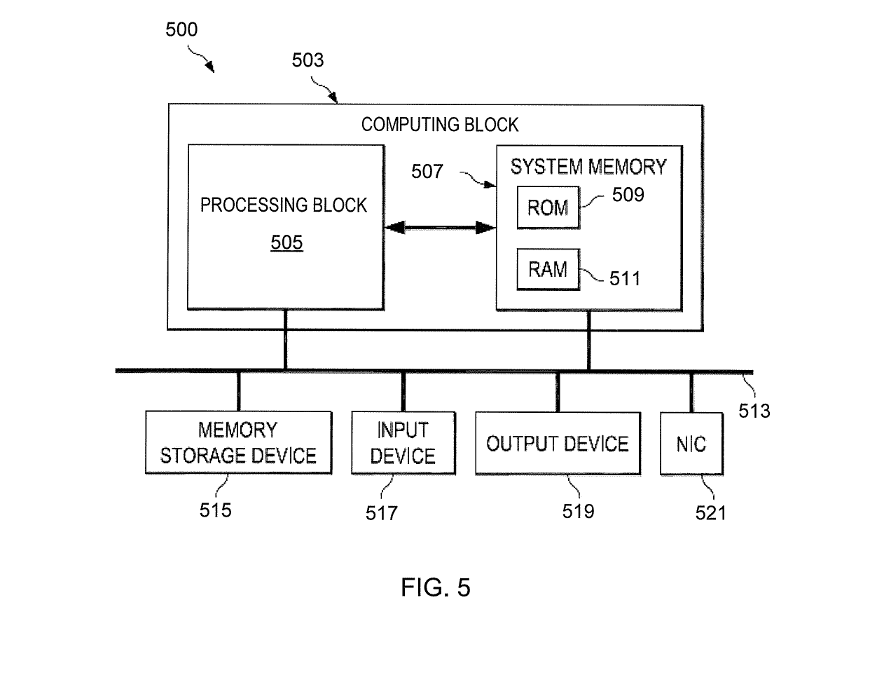

FIG. 1 illustrates a block diagram of a hotel search and display method 100 in accordance with the present disclosure. The hotel search and display method 100 can be used as part of an overall travel planning system or as a stand-alone search for hotels. The hotel search and display method 100 is capable of providing an individual trip display, for one destination, or an itinerary display, for multiple destinations. While the hotel search and display method 100 is described with respect to a hotel search, it will be understood that the same or a similar method may be used for other types of lodging (e.g., motels, resorts, vacation rentals, inns, etc.), and travel services other than lodging (e.g., air travel, car rental, travel activities, etc.). The method 100 may be performed by a computing device, such as the computing device described in FIG. 5 below.

The hotel search and display method 100 starts with the computing device determining a new trip destination at operation 120. The destination can be determined from previously entered information or received directly from information input by the user. The information on a specific destination is stored in a cache based upon a trip ID. The trip ID identifies trip information pertinent to travel including, but not limited to, destination, arrival date, departure date, number of people, hotel, and any other information important to hotel selection. An itinerary may include one or more individual trip IDs.

Once a new trip destination is determined, the computing device determines if the user needs a hotel at the trip destination, at operation 130. The computing device determines if the user needs a hotel using one or more queries of information found automatically by the computing device or input from the user. If the user does not need a hotel, the method 100 returns to operation 120 for the next available destination.

If the user needs a hotel 130, then the computing device proceeds to operation 140 to search for hotels at the destination. In operation 140, the method 100 searches for hotels and builds a pool of hotels, each hotel identified by a hotel ID. The pool of hotels is stored in a cache, memory, or other data storage. The cache may be indexed by one or more of a member ID, the trip ID, and the hotel ID.

Once all hotels at the destination are found, the computing device then filters the pool of hotels into a filtered group of hotels at operation 150. Once the hotels are filtered, the computing device sorts the filtered group of hotels into a hotel list at operation 160 and displays the sorted list on a display for the user at operation 170. In an embodiment, the user may be presented with three hotels in the initial display. The user may click on a “more hotels” function which expands the list to a predetermined amount. In an embodiment, the predetermined amount is ten hotels. It will be understood that the initial display and the expanded display may include more or fewer hotels.

In some embodiments, when the user indicates a specific hotel in the list (e.g., by hovering a pointer over the specific hotel), a pop-up window opens which shows one or more reasons why the specific hotel is included in the list. For example, the window may indicate that the hotel was previously booked by the user, that the hotel was previously booked by a buddy of the user, that the hotel is part of the user's favorite loyalty program, or any combination of these.

When the user clicks on, or otherwise selects, a hotel in the displayed hotel list, a separate pop-up window may display one or more hotel details. The hotel details pop-up may list the room types and rates and contain appropriate input fields for booking. In an embodiment, the input fields for booking include a “book now” button. The “book now” button guides the user to the appropriate booking page of a travel booking service. An example of a travel booking service is EXPEDIA.

Once the computing device displays the hotel list, the computing device repeats operations 120 through 170 until a new trip destination is not found, at which point the method 100 is completed and the search ends.

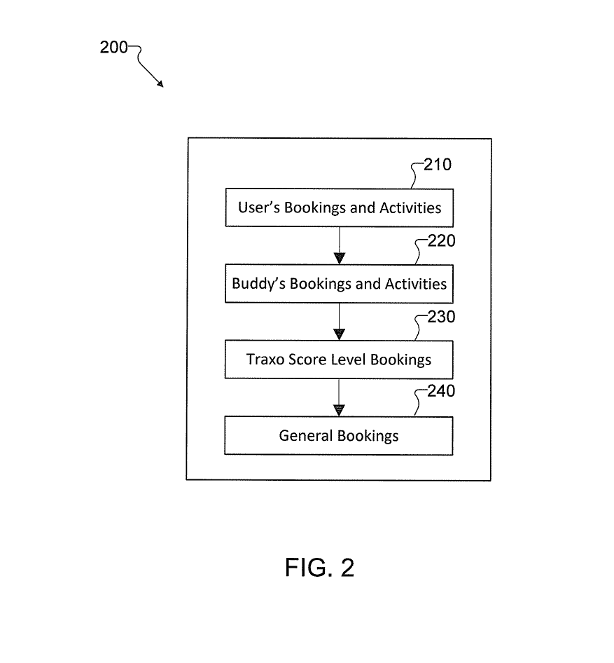

FIG. 2 illustrates a block diagram of a searching method 200 in accordance with the present disclosure. The searching method 200 may represent the hotel search operation 140 of FIG. 1. The order of operations disclosed in the searching method 200 can be arranged in any manner.

The searching method 200 begins in operation 210, in which the computing device considers the user's previous bookings at the destination. In more detail, the computing device determines all of the user's prior bookings of hotel segments in or near the specific city, state/province, and country of the destination. In some embodiments, the city, state/province, and country information may be stored as a geocode (e.g., latitude and longitude). In some embodiments, for a hotel to qualify in the search, a hotel identifier must be determined by matching the previously booked hotel property with the hotel property database. Along with the hotel, the most recent check in date, number of stays, and the rating are stored in the data.

If an insufficient number of available properties is found, the geographic center of hotels in the pool is determined and the value is used in a less targeted search. For example, if fewer than 10 unique hotels in the user's bookings on previous trips exist in the specific city, then the search may be expanded to find previously booked hotels within a larger area (e.g., a fifty mile radius).

If the user has no current or past hotel bookings for the larger geographic area, the computing device may gather information regarding current or past activities (e.g., restaurants visited, sporting events or concerts attended, businesses visited, etc.) and perform a proximity search for hotels based upon the geographic center of those activities.

Each of the hotels found in the search are de-duplicated (i.e., duplicates are eliminated) and included in a pool of booked hotels. Hotels at which the user has stayed three or fewer times with a low travel rating (e.g., the user's own TRAXO star rating of 1 or 2) may be removed from the pool of booked hotels.

If the search of the user's previous bookings in operation 210 does not produce the number of requested hotels, then the computing device proceeds to operation 220 to consider bookings by one or more of the user's buddies at the destination.

In operation 220, the computing device searches for other buddies' bookings with hotel segments associated with that specific city, state/province, and country. As with the operation 210, for a hotel to qualify for the search, a hotel identifier must be determined by matching the previously booked hotel property with the hotel property database. Along with the hotel, the most recent check in date, number of stays, and the hotel rating are stored in the data. If an insufficient number of available properties is found, the geographic center of hotels in the pool is determined and the value is used in a less targeted search. Each of the hotels are de-duplicated and included in a pool of booked hotels. Hotels at which the user's travel buddies have stayed three times or less with a low travel rating may be removed from the pool of booked hotels. If the user's travel buddies have no current or past hotel bookings for that location area, the computing device can gather current or past data about activities (e.g., restaurants visited, sporting events or concerts attended, businesses visited, etc.) and perform a proximity search for hotels based upon the geographic center of those to activities.

If the combined number of hotels of the user's previous bookings and the user's buddy's bookings in operations 210 and 220 is less than the number of requested hotels, then the computing device proceeds to operation 230 to consider hotels currently or previously booked by other users that have similar travel scores (e.g., TRAXO travel scores) as the user. As used herein, a user's travel score is an indication of how “travel savvy” the user is, and is based on one or more parameters associated with the user, such as how many trips the user has taken, how many destinations the user has traveled to, what kinds of properties the user has stayed in, how long the user has traveled to (or stayed in) each destination, and the like.

The computing device selects other users within a set range on either side of the user's travel score. For example, if a user has a TRAXO travel score of 73, the method may select a group of other users with a TRAXO travel score in a range of 63-83. A TRAXO travel score may be stored with each user's ID. Once a group is determined, the computing device considers hotels booked by the group of users to that specific destination. In some embodiments, a first search could consider hotels close to the destination, and a second search could consider hotels in a larger geographical area, such as described above with respect to the user or a travel buddy.

In some embodiments, TRAXO travel score level bookings can be examined on a regular basis to determine the top properties in each city per TRAXO travel score level. Therefore, the computing device would not have to repeat the process every time the user searches for a hotel. The TRAXO travel score level bookings could be determined daily, weekly, monthly or at any other suitable interval of time.

If the combined results of the searches in operations 210-230 still do not produce the required number of hotels, then the computing device proceeds to operation 240 to perform a general availability search using the search geocode and dates within a geographical location (e.g., a fifty mile radius).

The number of requested properties in the search is passed as a parameter. In this embodiment, the number of requested properties is 10. In other embodiments, the number of requested properties could be more than 10 or less than 10.

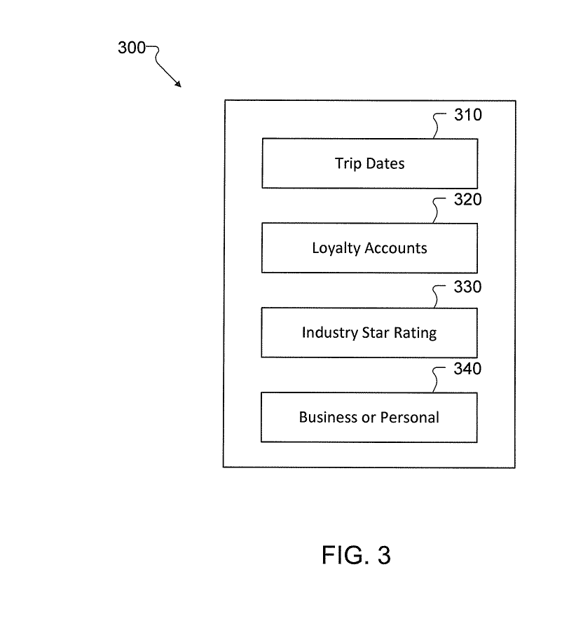

FIG. 3 illustrates a list of search filters 300 in accordance with the present disclosure. The search filters 300 may be used in connection with the hotel filtering operation 150 in FIG. 1. The search filters 300 are in no specific order and are not an exhaustive list of filters. Any combination of one or more of the search filters 300 can be used.

The hotel results can be filtered with the user's trip dates 310 for availability during the trip. In some embodiments, even if hotels do not have availability over the entire duration of the trip, the hotels are not removed from the data and may still be displayed.

The user's ID, account, or record contains information about different loyalty accounts 320 which the user possesses. The system may also check different services for new or updated information on loyalty accounts 320 in its local database. For each loyalty account, the pool of searched or displayed hotels may be adjusted based on the user's status. In some embodiments, the brands with the highest user status will be favored and will be shown first on the display list.

For example, a user may be affiliated with two different hotel brand loyalty programs, and may have achieved a gold status level with the first hotel brand, but only a silver status level with the second hotel brand. Since the user has obtained a higher status level with the first hotel brand, the first hotel brand may be favored and shown first on the display list. Hotel brands in which the user has not achieved any status level or in which the user is not enrolled in the loyalty program may be displayed even further down the display list.

Third party hotel ratings 330 (e.g., an industry star rating) are known for many hotels and may be used as a filter for search or display results. In some embodiments, third party hotel ratings may be adjusted by taking each unique hotel which the user stays at which does not have a rating of 0.0 and averaging the ratings. Using unique hotels helps to not skew the user's true preferences.

Search and display results may also be filtered based on whether the trip is business or leisure 340. The trip record associated with the trip ID includes information as to whether the trip is business or leisure 340 for each trip taken. The computing device can use that information as a filter when the user is searching for a hotel. For example, in some embodiments, the computing device can divide the user's prior hotel bookings into business and leisure categories. If the current trip is for business, the computing device may consider only hotels from past business trips; similarly, if the current trip is for leisure, the computing device may consider only hotels from past leisure trips.

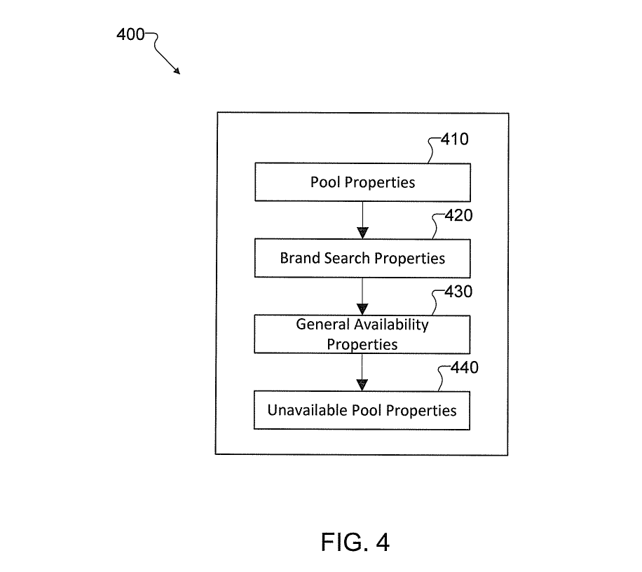

FIG. 4 illustrates a block diagram of a hotel display list sort function 400 in accordance with the present disclosure. The display list sort function 400 may be used in connection with the sorting and displaying operation 160 in FIG. 1. The displayed results of the hotel sort function 400 are merely one embodiment. Other hotel sort functions 400 may include other displayed results.

Once a result set of available hotel properties is determined (e.g., using one or more of the search methods and filters described above), the available properties based on the pool of previous user bookings 410 are presented first. The properties are first ordered by brand with the highest status, with a secondary sort for brand with equal status based on the most recent stay date. The available properties within a particular brand or loyalty program 420 are presented next on the list. Once again, the hotels are ordered first by status level, followed by a secondary sort for hotels with equal status level based on the most recent stay date. The next hotels listed are the general availability properties 430, which are sorted based on proximity to the geographic center of the trip location. The last hotels listed are the unavailable pool properties 440. Since these are unavailable, there is no need to sort them when presented to the user. The purpose of listing the unavailable hotels is to show the user that they have been considered and not left out. In some embodiments, the unavailable properties from the brand search 420 and the general availability properties 430 are not displayed; however, these may be displayed in other embodiments.

FIG. 5 illustrates an example of a computing device 500 for performing all or a portion of any of the methods or filtering routines for hotel or travel searching described herein. In general, the methods disclosed herein may be performed using a parallel computing platform comprising a plurality of computing nodes, such as a data center that includes multiple servers connected by a network. Each computing node may be represented by one computing device 500. The parallel computing platform may have as few or as many computing nodes (e.g., computing devices 500) as needed to perform the disclosed methods.

As shown in FIG. 5, the computing device 500 includes a computing block 503 with a processing block 505 and a system memory 507. The processing block 505 may be any type of programmable electronic device for executing software instructions, but will conventionally be one or more microprocessors. The system memory 507 may include both a read-only memory (ROM) 509 and a random access memory (RAM) 511. As will be appreciated by those of skill in the art, both the read-only memory 509 and the random access memory 511 may store software instructions for execution by the processing block 505.

The processing block 505 and the system memory 507 are connected, either directly or indirectly, through a bus 513 or alternate communication structure, to one or more peripheral devices. For example, the processing block 505 or the system memory 507 may be directly or indirectly connected to one or more additional memory storage devices 515. The memory storage devices 515 may include, for example, a “hard” magnetic disk drive, a solid state disk drive, an optical disk drive, and a removable disk drive. The processing block 505 and the system memory 507 also may be directly or indirectly connected to one or more input devices 517 and one or more output devices 519. The input devices 517 may include, for example, a keyboard, a pointing device (such as a mouse, touchpad, stylus, trackball, or joystick), a touch screen, a scanner, a camera, and a microphone. The output devices 519 may include, for example, a display device, a printer and speakers. Such a display device may be configured to display video images. With various examples of the computing device 500, one or more of the peripheral devices 515-519 may be internally housed with the computing block 503. Alternately, one or more of the peripheral devices 515-519 may be external to the housing for the computing block 503 and connected to the bus 513 through, for example, a Universal Serial Bus (USB) connection or a digital visual interface (DVI) connection.

With some implementations, the computing block 503 may also be directly or indirectly connected to one or more network interfaces cards (NIC) 521, for communicating with other devices making up a network. The network interface cards 521 translate data and control signals from the computing block 503 into network messages according to one or more communication protocols, such as the transmission control protocol (TCP) and the Internet protocol (IP). Also, the network interface cards 521 may employ any suitable connection agent (or combination of agents) for connecting to a network, including, for example, a wireless transceiver, a modem, or an Ethernet connection.

It should be appreciated that the computing device 500 is illustrated as an example only, and it not intended to be limiting. Various embodiments of this disclosure may be implemented using one or more computing devices that include the components of the computing device 500 illustrated in FIG. 5, or which include an alternate combination of components, including components that are not shown in FIG. 5. For example, various embodiments of the invention may be implemented using a multi-processor computer, a plurality of single and/or multiprocessor computers arranged into a network, or some combination of both.

In some embodiments, various functions described above are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. A controller may be implemented in hardware or a combination of hardware and software/firmware. The functionality associated with any particular controller may be centralized or distributed, whether locally or remotely. The phrase “at least one of,” when used with a list of items, means that different combinations of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for recommending travel services, comprising:
determining that a travel service is required for a trip destination of a user;
selecting a pool of travel services associated with the trip destination;
filtering the pool of travel services into a filtered group of travel services using one or more filters;
sorting the filtered group of travel services into a list using one or more sort criteria; and
displaying the list on a display for the user.

2. The method of claim 1, wherein selecting the pool of travel services associated with the trip destination comprises:
determining whether any travel services are associated with a prior booking by the user at the trip destination and, if so, including the travel services in the pool of travel services; and
upon a determination that the number of travel services associated with a prior booking by the user at the trip destination is less than a predetermined threshold, determining whether any travel services are associated with a prior booking by the user in a larger geographical area surrounding the trip destination, and if so, including the travel services in the pool of travel services.

3. The method of claim 2, wherein selecting the pool of travel services associated with the trip destination further comprises:
determining whether any travel services are associated with a booking by one or more buddies of the user at the trip destination and, if so, including the travel services in the pool of travel services; and
upon a determination that the number of travel services associated with a booking by one or more buddies of the user at the trip destination is less than a predetermined threshold, determining whether any travel services are associated with a booking by the user in a larger geographical area surrounding the trip destination, and if so, including the travel services in the pool of travel services.

4. The method of claim 2, wherein selecting the pool of travel services associated with the trip destination further comprises:
determining one or more second users that have a travel score in a range of travel scores associated with a travel score of the user;
determining whether any travel services are associated with a booking by the one or more second users at or near the trip destination and, if so, including the travel services in the pool of travel services.

5. The method of claim 1, wherein selecting the pool of travel services associated with the trip destination comprises:
determining whether any travel services are associated with a prior booking by the user at the trip destination; and
upon a determination that the number of travel services associated with a prior booking by the user at the trip destination is less than a predetermined threshold, searching for activities of the user at the trip destination, and searching for travel services based on a geographic center of the activities.

6. The method of claim 1, further comprising:
removing a travel service from the pool of travel services upon a determination that the travel service has a low travel rating and has been booked by the user or the one or more buddies fewer than a predetermined number of times.

7. The method of claim 1, further comprising:
displaying, in response to an indication that a display pointer hovers over a travel service among the displayed list, at least one reason why the travel service is included in the displayed list.

8. The method of claim 1, wherein the one or more filters comprises:
loyalty account information of the user for at least one travel service in the pool of travel services;
an average industry travel service rating for at least one travel service in the pool of travel services; and
an indication that the trip is a business trip or a personal trip

9. The method of claim 1, further comprising:
removing a travel service from the pool of travel services when it is determined that the user has provided a low rating for a previous usage of the travel service unless the user has subsequently booked the travel service after the user provided a low rating for a previous usage.

10. The method of claim 1, further comprising:
dividing the user's prior travel service bookings into business and leisure categories;
if the current trip is for business, considering only travel services from past business trips; and
if the current trip is for leisure, considering only travel services from past leisure trips.

11. A system for recommending travel services, the system comprising:
at least one memory; and
at least one processor coupled to the at least one memory, the at least one processor configured to:
determine that a travel service is required for a trip destination of a user;
select a pool of travel services associated with the trip destination;
filter the pool of travel services into a filtered group of travel services using one or more filters;
sort the filtered group of travel services into a list using one or more sort criteria; and
display the list on a display for the user.

12. The system of claim 11, wherein the at least one processor is configured to select the pool of travel services associated with the trip destination by:
determining whether any travel services are associated with a prior booking by the user at the trip destination and, if so, including the travel services in the pool of travel services; and
upon a determination that the number of travel services associated with a prior booking by the user at the trip destination is less than a predetermined threshold, determining whether any travel services are associated with a prior booking by the user in a larger geographical area surrounding the trip destination, and if so, including the travel services in the pool of travel services.

13. The system of claim 12, wherein the at least one processor is further configured to select the pool of travel services associated with the trip destination by:
determining whether any travel services are associated with a booking by one or more buddies of the user at the trip destination and, if so, including the travel services in the pool of travel services; and
upon a determination that the number of travel services associated with a booking by one or more buddies of the user at the trip destination is less than a predetermined threshold, determining whether any travel services are associated with a booking by the user in a larger geographical area surrounding the trip destination, and if so, including the travel services in the pool of travel services.

14. The system of claim 12, wherein the at least one processor is further configured to select the pool of travel services associated with the trip destination by:
determining one or more second users that have a travel score in a range of travel scores associated with a travel score of the user;
determining whether any travel services are associated with a booking by the one or more second users at or near the trip destination and, if so, including the travel services in the pool of travel services.

15. The system of claim 11, wherein the at least one processor is further configured to:
remove a travel service from the pool of travel services upon a determination that the travel service has a low travel rating and has been booked by the user or the one or more buddies fewer than a predetermined number of times.

16. The system of claim 11, wherein the at least one processor is further configured to:
display, in response to an indication that a display pointer hovers over a travel service among the displayed list, at least one reason why the travel service is included in the displayed list.

17. The system of claim 11, wherein the one or more filters comprises:
loyalty account information of the user for at least one travel service in the pool of travel services;
an average industry travel service rating for at least one travel service in the pool of travel services; and
an indication that the trip is a business trip or a personal trip

18. The system of claim 11, wherein the at least one processor is further configured to:
remove a travel service from the pool of travel services when it is determined that the user has provided a low rating for a previous usage of the travel service unless the user has subsequently booked the travel service after the user provided a low rating for a previous usage.

19. The system of claim 11, wherein the at least one processor is further configured to:
divide the user's prior travel service bookings into business and leisure categories;
if the current trip is for business, consider only travel services from past business trips; and
if the current trip is for leisure, consider only travel services from past leisure trips.

20. A non-transitory computer readable medium embodying a computer program, the computer program comprising computer readable program code for:
determining that a travel service is required for a trip destination of a user;
selecting a pool of travel services associated with the trip destination;
filtering the pool of travel services into a filtered group of travel services using one or more filters;
sorting the filtered group of travel services into a list using one or more sort criteria; and
displaying the list on a display for the user.
